(19) United States
(12) Patent Application Publication
(10) Pub. No.: US 2022/0036431 A1
(43) Pub. Date: Feb. 3, 2022

(54) PRODUCT LISTING MOCKUP GENERATOR

(71) Applicant: Peter Chin, Fontana, CA (US)

(72) Inventor: Peter Chin, Fontana, CA (US)

(21) Appl. No.: 16/940,722

(22) Filed: Jul. 28, 2020

(51) Int. Cl. G06Q 30/06; G06Q 30/02; G06Q 30/00; G06F 16/957; G06F 16/958; G06F 16/9038; G06F 16/9035

(52) U.S. Cl. CPC G06Q 30/0633; G06Q 30/0282; G06Q 30/01; G06F 16/9035; G06F 16/958; G06F 16/9038; G06F 16/9577

(57) ABSTRACT

A method of generating a product listing preview includes the steps of identifying using one or more processors a product listing corresponding to a user; then receiving user product listing data; then generating, using the one or more processors, a product listing mockup webpage based on the product listing; then displaying, using the one or more processors, the product listing mockup webpage to the user; then receiving a confirmation from the user, then using the one or more processors to generate a confirmed product listing webpage; and then publishing the confirmed listing webpage. An additional step may include receiving product data with text and graphics.

### FIELD OF THE INVENTION

The present invention is in the field of Internet product listing management.

### DISCUSSION OF RELATED ART

A variety of preview generators provide automated sales management systems. For example, in U.S. Pat. No. 9,763,477 Sales And Marketing Support System Using A Customer Information Database by inventor Anthony R. Melchione et al., published Jul. 27, 1999 the abstract discloses, “A sales process support system and method for identifying sales targets using a centralized database to improve marketing success. The system includes a central database that receives comprehensive information from a variety of internal and external feeds, and standardizes and households the information in a three-level hierarchy (households, customers, and accounts) for use by a financial institution. The comprehensive information stored on the central database is accessed through micromarketing workstations to generate lists of sales leads for marketing campaigns. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers, enhancing customer relationships with the financial institution, and electronically tracking sales and service performance during marketing campaigns. The system can also include a system for opening an account in a single session that is in communication with the central database, micromarketing centers, central customer information systems and branch systems of the present invention so that data can pass between these systems where legal and appropriate.”

Also for example, in U.S. Pat. No. 7,340,410 Sales Force Automation by inventor Xiaochun Zhu, published Mar. 4, 2008 the abstract discloses, “Method and apparatus for automating a sales force is described. More particularly, a sales force automation program is provided having a leads module, a commissions module and a forecasting module. Record objects, generated within a module, are automatically routed for processing. Such record objects are routed from one computer to another via the Internet. A server with the sales force automation program is coupled to a sales database for providing information from and to client computers accessing the sales force automation program.”

For example, in the U.S. Pat. No. 7,640,322 entitled Systems And Methods For Producing, Managing, Delivering, Retrieving, and/or Tracking Permission Based Communications by inventor Brad Wendkos, published Dec. 29, 2009 the abstract discloses, “New and improved methods and systems are provided for producing, managing, delivering, retrieving, and/or tracking permission communications that alleviate several of the existing problems commonly associated with existing permission communications. According to the invention, computer users can request to receive direct communications from one or more senders. When a new communication is detected, an alert is provided to the recipients, who can use the alert to view the communication in their Web browser. Similar alerts may also be provided to one or more recipients when particular Web pages are updated. Various alternative embodiments are also disclosed.”

For example, in U.S. Pat. No. 10,423,909 Method And System For Managing Business Deals by inventor Jason Winters, published Sep. 24, 2019 the abstract discloses, “In accordance with embodiments, there are provided mechanisms and methods for managing business deals. The mechanisms and methods for managing business deals may enable embodiments to provide a dynamic and interactive user-interface including any combination of contacts, accounts, opportunities, allowing users to create tasks, events, leads (e.g., from Data.com), reports, dashboards, instant messenger, external deal spaces, email service (e.g., Outlook), a cloud-based productivity suite for businesses that allows work on any device (e.g., Google apps), mobile access, private messaging, lead management, mass email templates, social media monitoring (e.g., from Radian6), role-based sharing and security, and/or additional storage, for example. In an embodiment, the number of contacts may be unlimited.”

Content previews are also shown such as in U.S. Pat. No. 8,060,466 Service For Accepting And Selectively Exposing User-Created Lists of Items by inventor Matthew J. Round et al., published Nov. 15, 2011 the abstract discloses, “Information retrieval systems and methods are disclosed for presenting items of interest to a user of a computer-based data repository, where the items are presented in the form of lists generated by other users. Users of a data repository may generate lists of items from the repository that are accessible by other users. In various embodiments, users generating lists may add supplemental commentary about the items and other personalizing information. The information retrieval systems and methods store the user-generated lists for future presentation to other users. When a user of the data repository submits a search query, items returned in the query's results are interpreted to be items of interest to the user, and in response, one or more lists determined to be similar to the items of interest are presented to the user.”

For example, in the United States patent number U.S. Pat. No. 8,909,594B2 Identifying an item based on data associated with the item by inventor Josh Loftus et al., published Dec. 9, 2014 the abstract discloses, “There are provided methods and systems to identify an item based on data associated with the item. Information is received that is descriptive of an item to be listed on an information storage and retrieval platform. The information is associated with an aspect-value pair, which is an aspect of the item and a value of the aspect. An expression of an interest of a user in the item is received. The expression is associated with the aspect-value pair. In response to the associating of the expression with the aspect-value pair, the item is identified.”

For example, in the United States patent number U.S. Pat. No. 9,270,714B2 Content preview generation using social network analysis by inventor Lorraine M. Herger, published Feb. 23, 2016 the abstract discloses, “Disclosed is a system and method for generating a preview of a digital content item using social network analysis. Members of a social network who acquire the digital content item may identify interesting portions of the digital content. When a member of the social network requests a preview of the digital content item, typically in anticipation of an acquisition of the digital content item, the interesting portions of the digital content item identified by fellow social network members are considered in the generation of the preview. Selection of the interesting content for preview may include more identified content, as well as social network relationship and role magnitudes. The digital content item may include: text, such as books or articles; multimedia such as audio/video; and interactive, such as games or virtual worlds.”

For example, in the United States patent number U.S. Pat. No. 9,953,378B2 Social checkout widget generation and integration apparatuses, methods and systems by inventor Thomas Purves, published Apr. 24, 2018 the abstract discloses, “The SOCIAL CHECKOUT WIDGET GENERATION AND INTEGRATION APPARATUSES, METHODS AND SYSTEMS (“CWI”) transforms developer credentials, codes and parameter inputs via the CWI component into buy widgets, payment acceptance and purchase transaction outputs. In one embodiment, the CWI may facilitate obtaining a plurality of authentication parameters and widget customization parameters. The CWI may authenticate a user using a parameter derived from the plurality of authentication parameters and may dynamically generate a purchase widget for the authenticated user using the plurality of widget customization parameters.”

For example, in U.S. Pat. No. 10,289,683 Browsing Or Searching User Interfaces And Other Aspects by inventor Julien Robert et al., published May 14, 2019 the abstract discloses, “User interfaces for browsing and/or searching are described. In one embodiment, a method includes displaying a first display area for display representations of documents matching a search query, the first display area configured to display content of the documents which can have a plurality of different types of content including at least one of text-based content and a folder, and displaying a second display area for selecting a selected document to be displayed in the first display area. Other embodiments are also described, and computer readable media and apparatuses are also described.”

### SUMMARY OF THE INVENTION

A variety of different product listings can be managed using a product listing mockup generator to generate a product listing preview on a client device using just text and photo data from the user. The product listing preview provides a sample look of a product listing before publishing a new product listing, or before pushing changes to a an existing product listing. A log and a means to query the log provide audit capability. Preferably, the user can receive a receipt containing the product listing mockup.

The receipts of the product listings can provide a means to determine the first sale of a product, log any trademarks used, and log any patents related to the product. Maintaining a complete catalog and record of product listings is physically impossible to accomplish using manual human effort due to the vast number of product listings and product data being managed.

A method of generating a product listing preview includes the steps of identifying using one or more processors a product listing corresponding to a user; then receiving user product listing data; then generating, using the one or more processors, a product listing mockup webpage based on the product listing; then displaying, using the one or more processors, the product listing mockup webpage to the user; then receiving a confirmation from the user, then using the one or more processors to generate a confirmed product listing webpage; and then publishing the confirmed listing webpage. An additional step may include receiving product data with text and graphics.

An additional step may include using one or more processors to receive a feedback from the user. An additional step may include using one or more processors to save a historical archive of published product listing webpages on a storage device. The user product listing data includes photographs and may have thumbnails associated with the photographs.

The user product listing data may include shipping information. The user product listing data preferably includes ratings. The user product listing data can include brand, title, and description text. The process may further include the step of generating a receipt and forwarding the receipt to the user. The receipt includes the product listing mockup.

### BRIEF DESCRIPTION OF THE DRAWINGS

FIG. 1 is a diagram of a client device.

FIG. 2 is a system diagram of a client device connecting to a server, which in turn can be connected to a first listing server, and a second listing server.

FIG. 3 is a diagram showing a product listing preview.

FIG. 4 is a diagram showing a photo preview.

FIG. 5 is a diagram showing a product description preview.

FIG. 6 is a process flow diagram showing the steps of the process.

The following call out list of elements can be a useful guide in referencing the element numbers of the drawings.
19 Integrated Preview
20 Photo Section
21 Main Photo
22 Thumbnail Photos
23 First Thumbnail
24 Second Thumbnail
25 Third Thumbnail
26 Fourth Thumbnail
27 Fifth Thumbnail
28 Sixth Thumbnail
29 Seventh Thumbnail
30 Title
31 Ratings
32 Price
33 Fit Indicator
34 Size
35 Description Text
36 Brand
40 Side Bar
41 Social Media Controls
42 Unit Price
43 Shipping
44 Return Info
45 Delivery Time
46 Stock Status
47 Cart Button
48 Buy Button
49 Options Input
50 Photo Preview
51 First Photo
52 Second Photo
53 Third Photo
54 Fourth Photo
55 Fifth Photo
56 Sixth Photo
57 Seventh Photo
58 Photo Caption
59 Photo View Frame
60 Product Description Preview
61 Size Chart
62 Specification Description
63 Tagline
64 Legal Stuff
65 Miscellaneous
88 Network
89 Approve Button
91 First Step
92 Second Step
93 Third Step
94 Fourth Step
95 Fifth Step
96 Sixth Step
100 Client Device
101 Client Device Microprocessor
102 Client Device Read-Only Memory
103 Client Device Random-Access Memory
104 Client Device Bus
105 Client Device Storage
106 Client Device Display Controller And Display Device
107 Client Device Input-Output Controller
108 Client Device Network Connection
109 Client Application
110 Server
111 Server Microprocessor
112 Server Read-Only Memory
113 Server Random-Access Memory
114 Server Bus
115 Server Storage
116 Server Input-Output Controller
117 Server Display Controller And Display Device
118 Server Network Connection
120 First Listing Server
121 First Listing Server Microprocessor
122 First Listing Server Read-Only Memory
123 First Listing Server Random-Access Memory
124 First Listing Server Bus
125 First Listing Server Storage
126 First Listing Server Input-Output Controller
127 First Listing Server Display Controller And Display Device
128 First Listing Server Network Connection
130 Second Listing Server
131 Second Listing Server Microprocessor
132 Second Listing Server Read-Only Memory
133 Second Listing Server Random-Access Memory
134 Second Listing Server Bus
135 Second Listing Server Storage
136 Second Listing Server Input-Output Controller
137 Second Listing Server Display Controller And Display Device
138 Second Listing Server Network Connection

### DETAILED DESCRIPTION OF THE PREFERRED EMBODIMENT

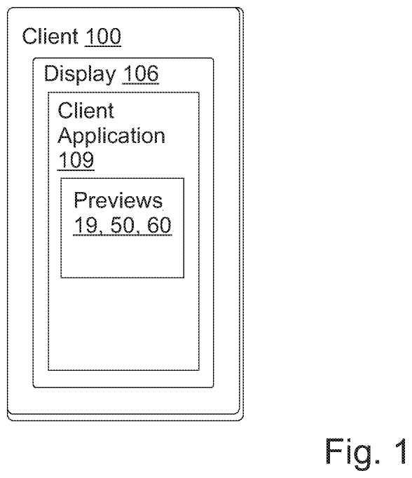

A client computing device has a product listing management application which includes a graphical user interface manager and a user input detector. As seen in FIG. 1, the client device 100 can be a desktop computer, laptop computer, cell phone, a virtual machine, tablet or the like and has a display 106. The display presents a client application 109 on a graphical user interface that provides previews 19, 50, 60 to the user.

The client computing device 100 can receive the product preview by email with an html attachment and the client application 109 can be a viewer. The client application 109 shows a product preview for a product listing on an online marketplace. The online marketplace can bean online retail platform service such as Amazon, eBay, Kickstarter, or Etsy. The user responds to the product preview by reviewing the product preview and approving it. The approval is sent to the server for pushing the changes to the online retail platform.

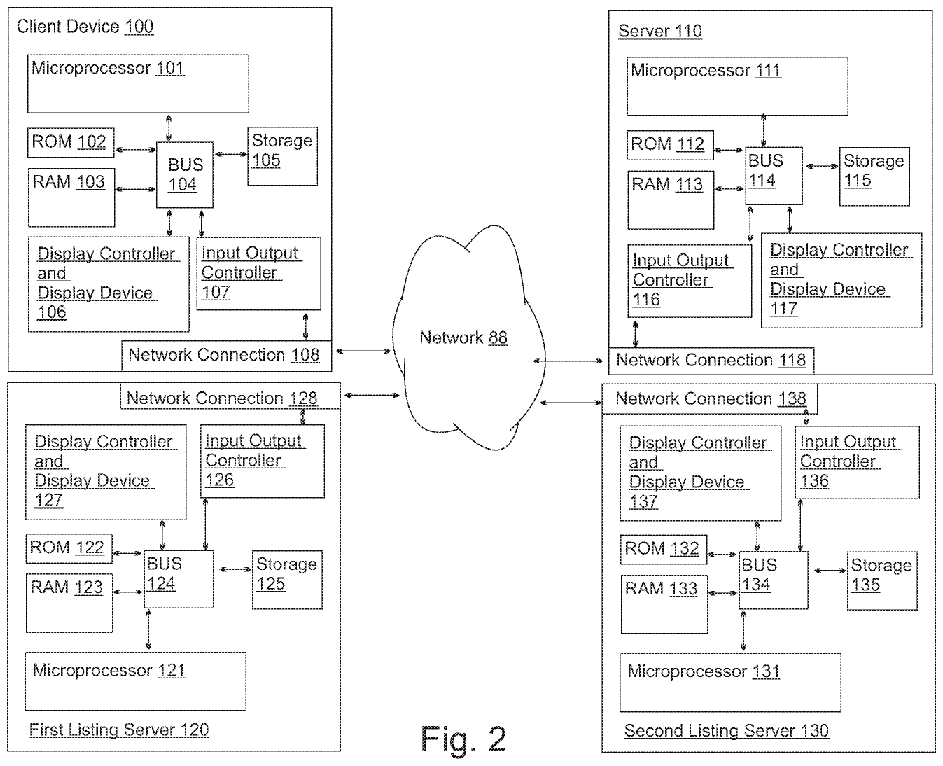

The present invention is implemented on a network infrastructure. As seen in FIG. 2, a client device 100 has a client device microprocessor 101 that facilitates a client application. The client device microprocessor 101 communicates with a client device bus 104. The client device bus 104 interconnects the client device read-only memory 102, client device random-access memory 103, and client device storage 105. The client device display controller and display device 106 and client device input-output controller 107 are also connected to the client device bus 104. The bus as described herein includes a plurality of busses of different protocols. The client device 100 has a client device network connection 108 that allows the client device 100 to connect to the network 88 which can be a wide area network such as the Internet, or a local area network.

Through the network 88, the client device 100 connects to a server 110. The server has a server microprocessor 111 such as a CPU that facilitates a server side application. The server also includes a server read-only memory 112 and a server random-access memory 113 connected to a server bus 114. The bus 114 also connects to a server storage 115 and also to a server input-output controller 116 and a server display controller and display device 117.

The server network connection 118 also connects to the network 109 which connects the server 110 to the first listing server 120 and the second listing server 130. In this way, the server 110 can facilitate a product preview for the client device 100, the data which is then pushed to the first listing server 120 or the second listing server 130.

The first listing server 120 can be a website such as an electronic commerce website that lists products on a virtual marketplace. The first listing server 120 also has a first listing server microprocessor 121 facilitating the operation of the first electronic commerce website. The first listing server read-only memory 122 and a first listing server random-access memory 123 are connected to a first listing server bus 124. The first listing server bus 124 is connected to the first listing server storage 125, the first listing server input-output controller 126, and first listing server display controller and display device 127. The first listing server input-output controller 126, has a first listing server network connection 128 connecting to the network 88. Similarly, the second listing server 130 has a second listing server microprocessor 131 that facilitates a second virtual marketplace. The second listing server read-only memory 132 and the second listing server random-access memory 133 are connected on a second listing server bus 134. The second listing server bus 134 also connects to a second listing server storage 135, a second listing server input-output controller 136, and a second listing server display controller and display device 137. The second listing server input-output controller 136 also has a second listing server network connection 138 connecting to the network 88.

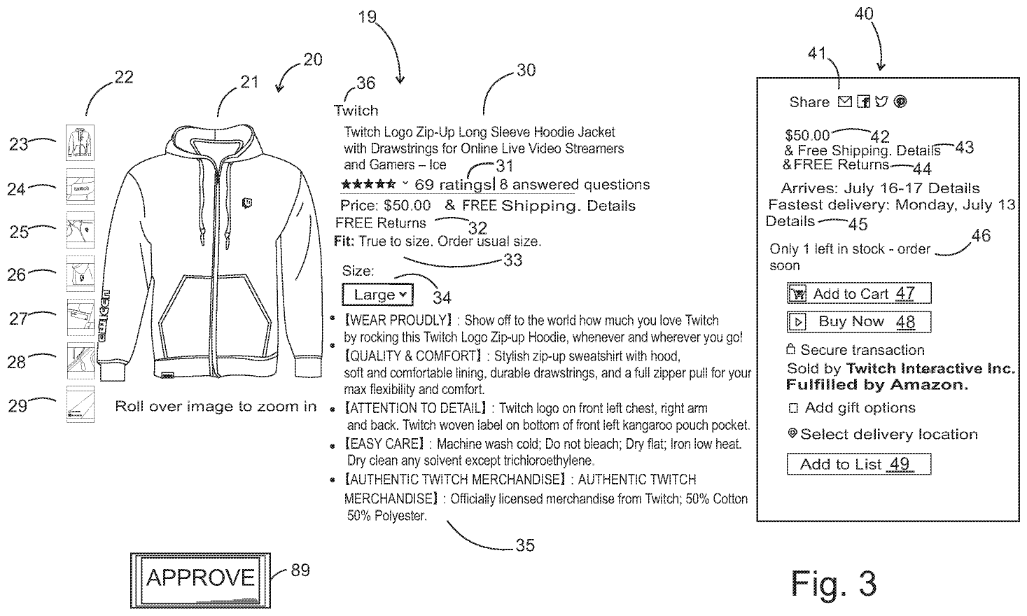

As seen in FIG. 3, the client application 109 can provide a product listing preview 19 on a standalone application, a web browser, or the like. The product listing preview 19 can be an integrated preview 19. The integrated preview can have a photo section 20 with a main photo 21 and a plurality of thumbnail photos 22 such as a first thumbnail 23, a second thumbnail 24, a third thumbnail 25, a fourth thumbnail 26, a fifth thumbnail 27, a sixth thumbnail 28, and a seventh thumbnail 29. These photo assets can provide a useful confirmation of the photos to be posted on the live product listing.

The client application 109 also displays the product listing preview 19 including the title 30, ratings 31, price 32, a fit indicator 33 if any, a size 34 if any, description text 35, and the brand 36. A side bar 40 can have social media controls 41 denoted by icons, a unit price 42, shipping 43, return info 44, delivery time 45, stock status 46, a cart button 47, and a buy button 48. Options input 49 can also be populated when the server 110 retrieves the options input 49 from the listing server. The user interface for the user client application 109 will have a confirmation button 89 for the product listing preview 19.

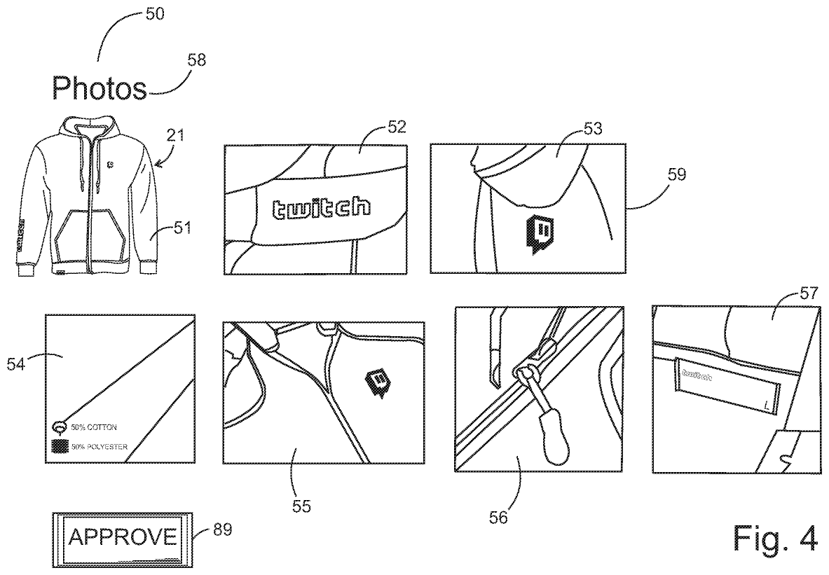

As seen in FIG. 4, a photo preview 50 may include a main photo 21. The photo preview 50 preferably includes the first photo 51, the second photo 52, the third photo 53, the fourth photo 54, the fifth photo 55, the sixth photo 56, the seventh photo 57, the photo caption 58, and the photo view frame 59. User interface for the user client application 109 will have a confirmation button 89 for the photo preview 50.

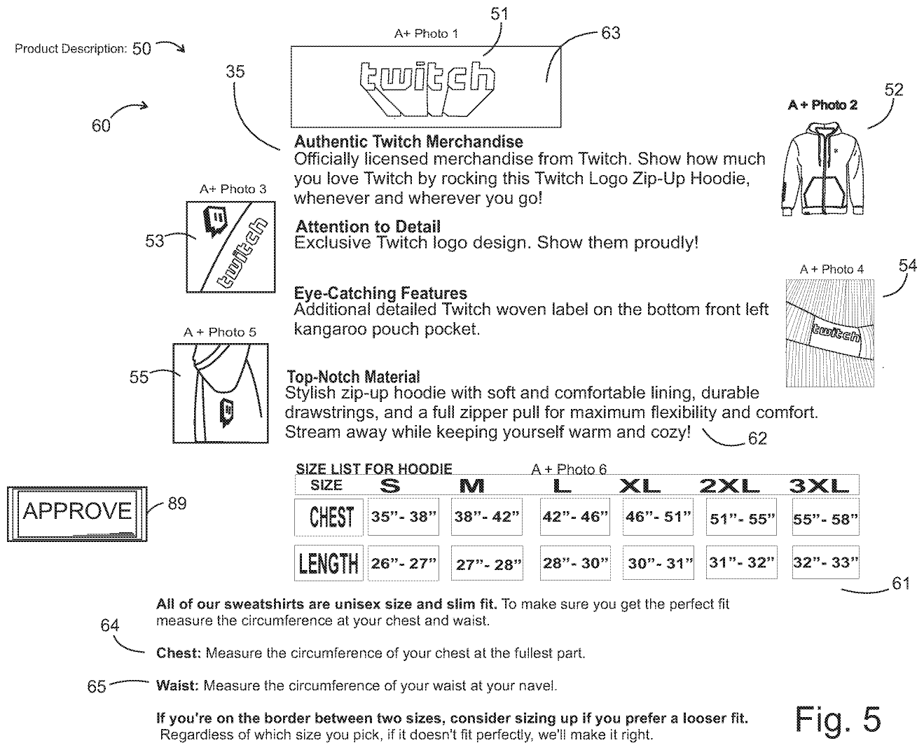

As seen in FIG. 5, a product description preview 60 includes description text 35, a first photo 51, a second photo 52, a third photo 53, a fourth photo 54, a fifth photo 55, a size chart 61, a specification description 62, and a tagline 63. The product description preview 60 may further include legal or technical notices such as legal stuff 64, composed of sometimes indecipherable text such as legal jargon, legal notices and the like which are retrieved from the first listing server 120, or the second listing server 130. Legal stuff 64 can be repopulated on the preview. For the faint of heart, instead of repopulating legal stuff 64 as text, the preview can have legal stuff 64 formed as a text box with a title “Legal Stuff” that does not display in full unless the user clicks on it. The product description preview 60 also may include miscellaneous 65 which is text downloaded from the listing server such as a first listing server 120, or a second listing server 130. The user interface for the user client application 109 will have a confirmation button 89 for the product description preview 60. When the user activates all three confirmation buttons 89, the preview is marked as approved and the server begins submission of updated product information and begins processing the update, or creation of the online product listing. The confirmation button 89 also is connected to the log function for retaining a graphical depiction of the confirmation as an image, such as a jpeg.

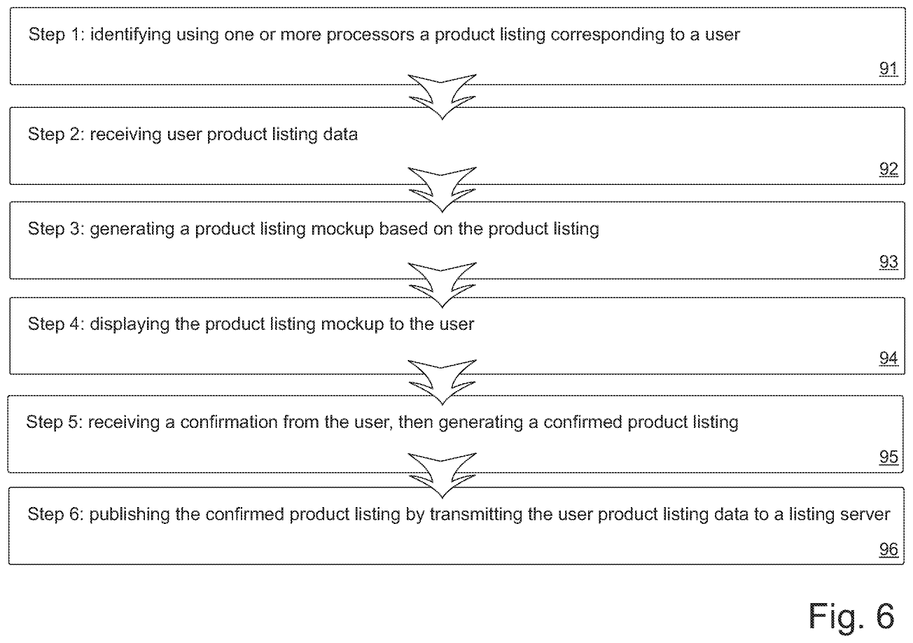

As seen in FIG. 6, the present invention includes several fundamental steps for practicing the method. The steps include a first step 91, a second step 92, a third step 93, a fourth step 94, a fifth step 95, and a sixth step 96. The first step 91 is to identify a product listing corresponding to a user. In the first step 91, the server 110 through the network 88 receives a listing from a first listing server 120, or a second listing server 130.

In the second step 92, the server 110 then receives user product listing data from the user's client 100. The user's client 100 can have a web browser that provides an interface to communicate with the server 110.

In the third step 93, the server 110 generates a product listing mockup based on the product listing data. The product listing mockup can be generated by querying the product listing URL (uniform resource locator), which is the web address. The server 110 can retrieve the webpage such as by downloading and saving the html (hypertext markup language) file. The server 110 can then populate downloaded graphical layout file with the user provided user product listing data. The downloaded or queried file is thus used as a template and the updated user product listing data from the user's client 100 is populated and sent to the user's client 100.

In the fourth step 94, the user's client 100 has a client application 109 that shows the preview 19, 50, 60 to the user.

In the fifth step 95, the user provides a confirmation or edited data to the server 110. If the user provides a confirmation, then the server 110 pushes the confirmed data to a listing server such as the first listing server 120, or the second listing server 130. Although two listing servers are described here, preferably more than that can be added depending upon the number of different electronic marketplaces that the user is participating in. If the user provides edited data to the server, then the process goes back to the second step 92. When the user confirms, the method proceeds to the sixth step 96.

In the sixth step 96, the server 110 publishes the confirmed product listing by transmitting the user product listing data to a listing server such as the first listing server 120, or the second listing server 130. The product listing server then makes the changes live. After making the changes live, the server 110 double checks the listing by downloading the product listing page URL and compares it against the generated preview. The server 110 logs and saves the generated preview and the published product listing page. These are saved on the server storage 115 and the user can query the server storage 115 to obtain a historical log.

The present invention can be a helpful confirmation and backup system even if the first listing server 120 or the second listing server 130 has their own internal historical log and saved product listing history in graphical format. The user therefore sends only the assets such as the text, and the photos to the server and the server will generate the product preview for the user without need for user client interaction with the listing server.

1. A method comprising the steps of:
identifying using one or more processors a product listing corresponding to a user;
receiving user product listing data;
generating, using the one or more processors, a product listing mockup webpage based on the product listing;
displaying, using the one or more processors, the product listing mockup webpage to the user;
receiving a confirmation from the user, then using the one or more processors to generate a confirmed product listing webpage; and
publishing the confirmed listing webpage.

2. The method of claim 1, wherein the product data includes text and graphics.

3. The method of claim 1, further including the step of using the one or more processors to receive a feedback from the user.

4. The method of claim 1, further including the step of saving a historical archive of published product listing webpages.

5. The method of claim 1, wherein the user product listing data includes photographs.

6. The method of claim 1, wherein the user product listing data includes shipping information.

7. The method of claim 1, wherein the user product listing data includes ratings.

8. The method of claim 1, wherein the user product listing data includes brand, title, and description text.

9. The method of claim 1, further including the step of generating a receipt and forwarding the receipt to the user, wherein the receipt includes the product listing mockup.

10. The method of claim 9, wherein the product data includes text and graphics.

11. The method of claim 9, further including the step of using the one or more processors to receive a feedback from the user.

12. The method of claim 9, further including the step of saving a historical archive of published product listing webpages.

13. The method of claim 9, wherein the user product listing data includes photographs.

14. The method of claim 9, wherein the user product listing data includes shipping information.

15. The method of claim 9, wherein the user product listing data includes ratings.

16. The method of claim 9, wherein the user product listing data includes brand, title, and description text.
